(19) United States
(12) Patent Application Publication
(10) Pub. No.: US 2011/0031374 A1
(43) Pub. Date: Feb. 10, 2011

(54) MOUNTING PLATE, MOUNTING SYSTEM, AND MOUNTING METHOD FOR DOOR ACTUATOR ARRANGEMENTS

(75) Inventors: Mattias DRUX, Gevelsberg (DE); Michael HUFEN, Wuppertal (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Co. KG, Ennepetal (DE)

(21) Appl. No.: 12/851,226

(22) Filed: Aug. 5, 2010

(30) Foreign Application Priority Data
Aug. 6, 2009 (DE) 10 2009 036 293.2
May 21, 2010 (DE) 10 2010 021 264.4

(51) Int. Cl. F16M 13/02; B23P 11/00

(52) U.S. Cl. 248/674; 29/525.02

(57) ABSTRACT

A mounting plate for a door actuator, adapted to move a door leaf in at least one direction. The mounting plate is configured to be attached to a body and has fastening devices for affixing the door actuator to the mounting plate. At least at one end, the mounting plate has a fastening portion that serves to affix a connecting member to a first section of the mounting plate.

### BACKGROUND OF THE INVENTION

1. Field of the Invention

The invention relates to a mounting plate for a door actuator, a mounting system equipped with a mounting plate, and a mounting method utilizing such a system.

2. Description of the Related Art

Door actuators, namely door closers or door operators, which are adapted to open and/or to close a connected door leaf, are usually affixed to a body such as a door frame or the like by a mounting plate. For this purpose, the respective mounting plate is attached to the body in advance. Thereupon, the associated door actuator is attached to the mounting plate; i.e. the mounting plate holds the door actuator.

If additional components, such as smoke detectors or the like are to be mounted with the door actuator, it is known to affix those components to the body next to the respective door actuator, which is disadvantageous from a visual point of view. In addition, connecting lines may have to be run between the component(s) and the door actuator and might be visible under the given circumstances, which involves the risk of people getting in contact with the lines, getting hurt or causing malfunctioning, if the lines were to be severed, or causing loose contacts, or unintentionally pulled.

In double-leaf door systems with one door actuator per door leaf, in which the actuators are to be covered by a cover shield, it is standard practice to provide a continuous mounting plate, at which the door actuators and possible other components are affixed. For such a mounting plate it is required to manufacture correspondingly long mounting plates in the factory. Considering that such door systems have different passage widths, this results in the door actuators having different distances to each other so a specifically adapted mounting plate needs to be produced for each door system. This circumstance has repercussions on distribution in that mounting plates need to be manufactured for single-leaf door actuators for doors, which plates are different from those for double-leaf door systems. In addition, the customer needs to know in advance for which type of door system the door actuators are required, which leads to an increased error rate. Add the disadvantage to this that the longer the mounting plate the lower its bending resistance. Therefore, additional efforts might be required to guarantee safe transport. In addition, a long mounting plate requires more transporting space, at least in the longitudinal extension. All in all, this becomes very cost-intensive.

In the event of retrofitting with a continuous cover shield, the door actuators need to be completely dismounted and reinstalled with the new, continuous mounting plate in an expensive manner. The individual door actuator mounting plates have now become useless and can not be reused, and the customer, in addition to the enormous mounting expense, has to bear the relatively high cost.

### SUMMARY OF THE INVENTION

Therefore, object of the invention is to at least reduce the shortfalls of the state-of-the-art.

An inventive mounting plate is designed for a door actuator which is adapted to move a connected door leaf in at least one direction. The mounting plate is configured to be attached to a body, for example a door frame, carrying the mounting plate. In addition, the mounting plate has fastening devices for affixing the door actuator to the mounting plate. The fastening devices comprise for example pilot pins for slipping the door actuator onto them and for temporarily holding the door actuator at the mounting plate, and/or screw holes, in which attachment screws of the door actuator are screwed tight for a final mounting of the door actuator. Seen in the longitudinal extension of the mounting plate, it has, at least at one end, a first fastening portion. This first fastening portion serves to affix a connecting member to a first section of the mounting plate, which, seen in the longitudinal extension of the connecting member, is oriented towards the mounting plate. The inventive mounting plate is not only adapted to stationarily receive a door actuator, but is furthermore also configured for affixing a connecting member. It is thereby possible to complete the mounting plate with another arrangement such that a modular-type mounting plate system can be formed.

The at least one fastening portion has preferably at least one through-opening. The through-opening is preferably provided with a female thread, such that the connecting member can be simply screwed to the mounting plate. As an alternative, the through-opening is configured as an oblong hole. This allows for displacing the connecting member, to compensate for possible tolerances between the mounting plate and the connecting member.

An inventive system for mounting at least one door actuator has a first mounting plate according to the above description for the at least one door actuator. Furthermore, the system preferably has an additional mounting plate, which has at least one second fastening portion for fastening a second section of the connecting member, briefly described above, and oriented towards the additional mounting plate. In addition, the system has such a connecting member. Seen in a longitudinal extension of the connecting member, it includes, at its ends, respectively one section according to the above explanation. Each section is configured as a fastening portion and adapted to be attached to a respective fastening portion of a respective one of the two existing mounting plates such that the two mounting plates affixed to the connecting member are held aligned with regard to each other according to predetermined specifications. It is thereby possible to align the mounting plates, adjoining each other, according to desired specifications, simply by mounting the connecting member, such that for example a continuous cover shield can be placed without any problem on all mounting plates, which are interconnected, that is affixed to each other via the connecting members. Laborious work to align the mounting plates is thus no longer necessary. The installation is extremely simple, error sources are reduced, and it is easier to adapt the system to the respective circumstances on site. It is particularly advantageous that the door actuators can still be delivered with their mounting plate. In the event smoke detectors or the like are to be additionally installed, the additional mounting plate is utilized for this purpose, which can be ordered separately. Thereby costs are reduced, because no mounting plate needs to be ordered, which carries the door actuator and the additional components, instead the additional mounting plate just receives these additional components. Thus the door actuator mounting plate is still used and does not unnecessarily end up in the landfill. The additional mounting plate is considerably shorter, such that costs are saved in this regard. In addition, retrofitting is very simple, because only the door actuators need to be removed, if they have to be removed at all, in order to be able to affix the additional mounting plate.

Furthermore, the above mentioned additional mounting plate is preferably configured to be attached to said body. The stability of the overall mounting plate arrangement is thereby increased.

Some of the fastening portions of the mounting plates are preferably likewise equipped with the aforementioned through-openings. Thereby, the parts can be simply screwed to each other, namely the mounting plates are screwed to the associated connecting member.

Preferably for each through-opening of the respective mounting plate to be affixed, the fastening portions of the respective connecting member comprise such a corresponding through-opening. Several through-openings can improve the mounting stability.

If two door actuators are to be affixed for example as an actuation device of a double-leaf swing door system, according to the invention, the system has in addition a second mounting plate, which is configured according to the first mounting plate. Identical mounting plates can be provided for the door actuators, as long as the door actuators are configured to be identical. If one door actuator is a door closer, therefore of relatively small built, and the other door actuator is a swing leaf drive, therefore of relatively large built, both associated mounting plates can be configured according to the invention and adapted to the respective door actuator. This enhances the universal application of such a system, because it is not important which type of door actuator is to be installed.

Seen in longitudinal extension, the respective connecting member preferably has a central portion between the two sections, which is configured as a fastening portion. According to the invention, the connecting member is adapted to be attached to the additional mounting plate by the central portion such that the first, the second, and the additional mounting plates, affixed to the connecting member, are held to be aligned to each other according to predetermined specifications. This solution is in particular advantageous if relatively little space is available between the mounting plates of the door actuators, such that two connecting members next to each other do not have enough space.

As described above, holding at least two mounting plates, which are stationarily disposed to each other, by a connecting member and aligned to each other, preferably includes that the mounting plates, affixed to the connecting member, are in true alignment. If the mounting plates, with regard to their exterior cross sectional shape, are at least partially configured to be identical, it can be thus achieved that the exterior surfaces of the mounting plates blend into one another without a transition, a circumstance which allows for mounting a continuous cover shield at the mounting plates, without complicating the installation of the mounting plates.

A mounting method can be realized with the inventive system, which method, according to the invention, comprises a first step of attaching each connecting member to the mounting plates, which are to be aligned with regard to each other by the respective connecting member and via their fastening portions, corresponding to each other, by respective fasteners. Furthermore, the method comprises thereupon a step of placing and attaching the thus configured unit, comprised of connecting member(s) and mounting plates, at or onto the body. This mounting method allows to initially mount the mounting plates aligned with regard to each other and to thereupon mount the overall formed mounting plate unit to the body without having to pay attention whether or not the mounting plates are still aligned to each other, when they are affixed to the body.

Preferably, the aforementioned fastening means comprise screws, such that fastening is accomplished by simply screwing the connecting member(s) to the respective mounting plate.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the invention will become apparent from the following description of preferred embodiments, in which:

FIG. 1 is an arrangement of installed mounting plates of a system for mounting door actuators, according to a first embodiment of the invention,

FIG. 2 is a portion of the arrangement of FIG. 1 in an exploded view;

FIGS. 3a and 3b are two sectional views along the line A-A in FIG. 1;

FIGS. 4a and 4b are two sectional views along the line B-B in FIG. 1;

FIG. 5 is an arrangement of installed mounting plates of a system for mounting door actuators, according to a second embodiment of the invention;

FIG. 6 is an arrangement of a mounting plate and of a connector of a system for mounting door actuators, according to a third embodiment of the invention;

FIG. 7 is an arrangement of installed mounting plates of a system for mounting door actuators, according to a fourth embodiment of the invention; and

FIG. 8 is a flowchart for mounting the arrangements according to FIGS. 1, and 5 to 7.

### DETAILED DESCRIPTION OF THE PRESENTLY PREFERRED EMBODIMENTS

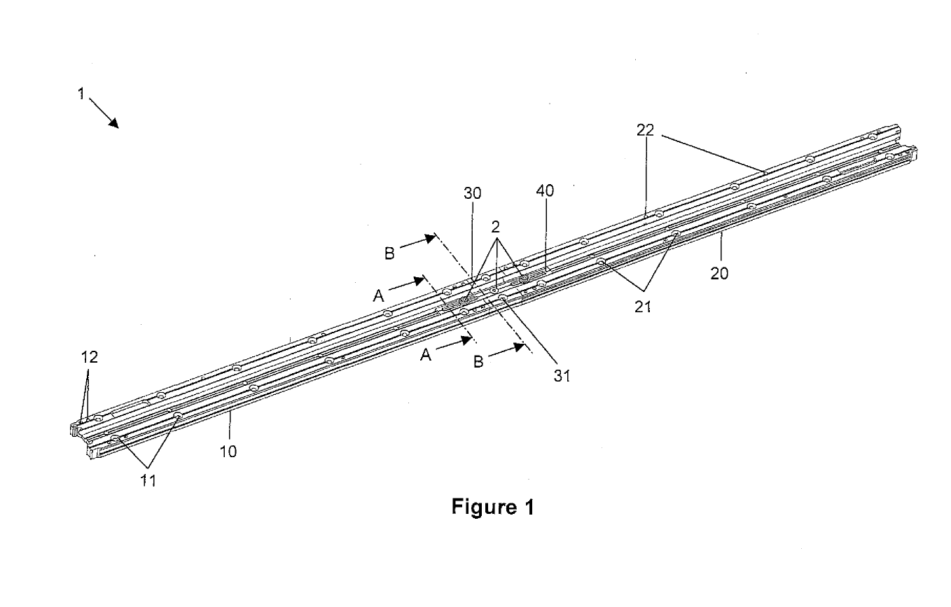

FIG. 1 shows a system 1 for mounting non-illustrated door actuators according to a first embodiment of the invention. By way of example, the system 1 comprises mounting plates 10, 20 for two such door actuators. Another mounting plate 30 is disposed between these two mounting plates 10, 20. Preferably, the mounting plate 30 is configured similarly to at least one of the mounting plates 10, 20, therefore has the same shape in cross section as the mounting plate 10, 20 disposed on the right and/or the left side thereof. Preferably, the mounting plates 10, 20 are configured to be rotationally-symmetric and furthermore to be identical to each other.

In the illustrated example, the mounting plates 10, 20 are provided with fastening openings 11, 21, which serve to stationarily affix the respective mounting plate 10, 20 to a body, such as a door frame or the like. By way of example, the mounting plates 10, 20 comprise furthermore reception openings 12, 22, which serve to receive for example non-illustrated pilot pins or the like, which are provided to temporarily or permanently hold the respective door actuator at the mounting plate 10, 20. For the sake of clarity, respectively only two of the openings 11, 12, 21, 22 are provided with reference numerals.

By way of example, also the intermediate mounting plate 30 has fastening openings 31 analogously to the fastening openings 11, 21 of the two other mounting plates 10, 20. The three mounting plates 10, 20, 30 are held in position with regard to each other and by way of example, affixed to each other by means of a single connecting member 40.

In the illustrated example, the connecting member 40 is affixed to the respective mounting plate 10, 20, 30 by way of example by respectively one associated attachment screw 2.

The mounting plates 10, 20, 30 and the connecting member 40 are configured such that the connecting member 40, when attached to the mounting plates 10, 20, 30, aligns them with regard to each other according to predetermined specifications. The specifications include preferably that the mounting plates 10, 20, 30 are in alignment to each other and that their exterior surfaces blend substantially seamlessly into one another, such that the entire arrangement results altogether in an overall smooth, respectively flat exterior surface, the mounting plates 10, 20, 30 thus terminate flush with each other.

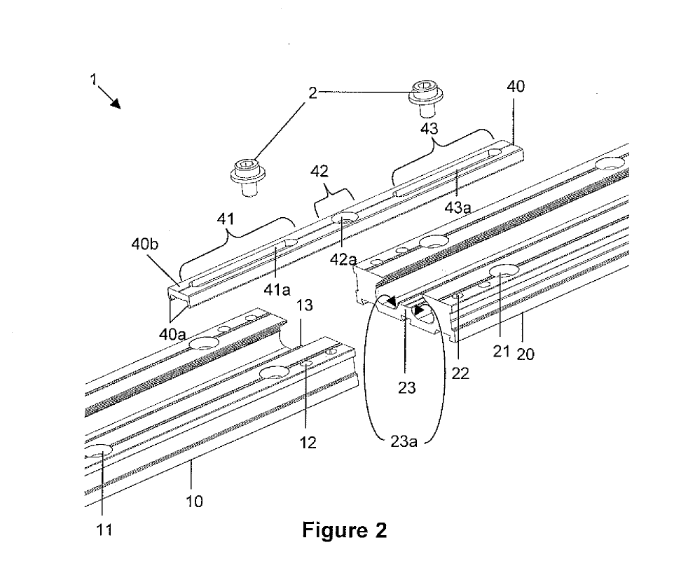

FIG. 2 shows the system 1, respectively the arrangement of FIG. 1 in an exploded illustration. The mounting plate 30 as well as the associated central attachment screw 2 according to FIG. 1 are missing in this view. In particular the mounting plates 10, 20 as well as their fastening openings 11, 21 and reception openings 12, 22 can be seen in this illustration, only one of them being respectively identified by a reference numeral. The mounting plates 10, 20 have fastening portions 13, 23 for placing the connecting members 40. By way of example, the fastening portions 13, 23 are formed by an essentially centrally disposed, respective projection that extends in the direction of the connecting member 40.

The respective projection is preferably configured over the entire length of the respective mounting plate 10, 20. It is therefore possible to manufacture the mounting plates 10, 20 from continuous casting profiles, respectively from extruded profiles and to simply cut them to the respective desired length. The fastening portions 13, 23, respectively the projections comprise lateral wall sections, only the lateral wall sections 23a of the fastening portion 23 being visible. By way of example, the connecting member 40 has a U-shaped cross-section, which comprises lateral wall sections 40a which are parallel to each other and are connected to each other at one end via a central wall section 40b. By way of example, the connecting member 40 comprises three fastening portions 41 to 43. The fastening portions 41, 43 comprise a respective fastening opening 41a, respectively 43a in the shape of oblong through-openings, whereas the central fastening portion 42 comprises an fastening opening 42a in the shape of a circular through-opening, by way of example in the shape of a counter-sunk hole.

The attachment screws 2 serve to affix the connecting member 40 to the respective associated mounting plate 10, 20 (or 30) by the respective associated fastening portion 41 to 43. The oblong holes allow for aligning mounting plates 10, 20 with regard to each other, which possibly have differently disposed fastening openings, and for affixing them, such that, by way of example, they firmly abut at the mounting plate 30, as shown in FIG. 1.

The mounting plate 30 is missing in the illustration of FIG. 2, as indicated. This should illustrate that the connecting member 40 is not only suitable to interconnect three mounting plates 10, 20, 30, but that it can be likewise utilized to only position the mounting plates 10, 20 with regard to each other. This is useful in door systems in which no space is available for the mounting plate 30 between the door actuator mounting plates 10, 20. In this case, one of the mounting plates 10, 20 can be affixed by means of both the respective facing, exterior fastening portion 41, or 43 and/or by means of the central fastening portion 42 of the connecting member 40.

Even if not visible in this illustration, the fastening portions 13, 23 have correspondingly configured fastening openings for the illustrated attachment screws 2, for example in the shape of through-openings preferably with a female thread, such that the associated attachment screw 2 can pass through the connecting member 40 and can be screwed into the respective mounting plate 10, 20.

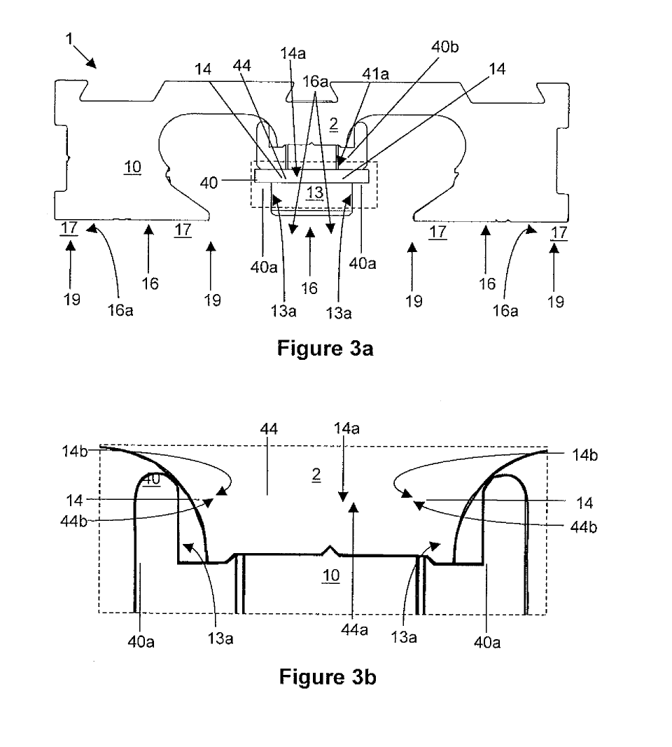

FIG. 3a shows the arrangement of FIG. 1 in a section along a line A-A according to FIG. 1, namely through the left mounting plate 10 in FIG. 1. As can be seen, the associated attachment screw 2 is screwed into the fastening portion 13 of the mounting plate 10 while passing through the fastening opening 41a of the connecting member 40. As an alternative it is possible to configure the fastening opening(s) without a thread in the fastening portion 13, which openings are not visible here, wherein the attachment screw 2 is then screwed to a nut below the mounting plate 10 and thus fixes the connecting member 40 to the mounting plate 10. Essentially, the fastening portion 13 can be configured complementary to reception space of the connecting member 40, which space is formed by the lateral wall sections 40a and the central wall section 40b.

In the illustrated example, the lateral wall sections 13a of the fastening portion 13 of the mounting plate 10, seen in cross-section of the mounting plate 10, are configured such that the fastening portion 13 tapers in the direction of the connecting member 40. The lateral wall sections 13a have a maximum distance with regard to each other which is larger than a maximum distance of the lateral wall sections 40a of the connecting member 40 with regard to each other. This entails that, just by placing the connecting member 40, it can not firmly abut against a surface 14a of the fastening portion 13 pointing to the top, namely in the direction of the connecting member 40. In order to achieve this abutting, the connecting member 40 is moved in the direction of the mounting plate 10 by screwing said attachment screw 2, wherein, in the illustrated example, on account of the lateral wall sections 13a of the mounting plate 10, the lateral wall sections 40a of the connecting member 40 are pressed away from each other, namely to the outside. This results in the connecting member 40 being braced in its position with regard to the mounting plate 10 and not being able to move any more. When attaching the connecting member 40, on account of joining the lateral wall sections 13a, 40a of the mounting plate 10 and of the connecting member 40, it is firmly positioned, centred in the illustrated example. By attaching the connecting member 40, to the mounting plate 10, their relative positions are determined with regard to each other. Therefore, a mechanic on-site no longer has to pay attention to the respective specifications of the mounting plates 10, 20, 30, in the present case to be in true alignment, in order to be able to place for example a continuous cover shield over all the mounting plates 10, 20, 30.

As an alternative, or in addition as illustrated in this case, the connecting member 40 has a positioning portion 44, which is formed by a projection pointing in the direction of the mounting plate 10. In the illustrated mounted condition, the mounting plate 10 has positioning portions 14, likewise configured as projections, which abut against the sides of this positioning portion 44.

In addition, at its side facing away from the fastening portion 13, the mounting plate 10 has preferably reception grooves 16, which are respectively adjoined by two projections 17. The projections 17 preferably terminate in respectively one plane surface 19.

Preferably, the surfaces 19 terminate flush with each other, such that a surface is created which serves for example as a support surface for the above described body.

By way of example, the central reception groove 16 is dove-tail shaped in cross-section. This means the groove has two lateral surfaces 16a, which, in the direction of the fastening portion 13, point away from each other and include an acute angle with regard to a respectively adjoining surface 19. The surfaces 16a, as will be explained later, preferably serve as guiding surfaces.

By way of example, in cross-section the lateral reception grooves 16 are configured as a parallelogram and mirror-inverted with regard to each other. They likewise have surfaces 16a, which include an acute angle with a respective adjoining surface 19.

The area, which is surrounded by a dashed line in FIG. 3a, is shown enlarged in FIG. 3b. As can be seen, the lateral wall sections 40a of the connecting member 40 are preferably rounded at their free ends, to facilitate their sliding along the lateral wall sections 13a of the mounting plate 10. Furthermore, a portion of the attachment screw 2 can be seen. In this case, the cooperation between the positioning portions 14, 44 can be particularly well seen. Similarly to the positioning portion 14, the positioning portion 44 has a support surface 44a, which is essentially disposed parallel to the support surface 14a in the mounted condition and bears against the support surface 14a.

Positioning surfaces 14b adjoin the support surface 14a laterally in cross-section. The positioning surfaces 14b extend away from the support surface 14a and towards the connecting member 40 in such a way that the surfaces 14a, 14b form a groove with a trapezoidal cross-section in this example, and that the groove widens in the direction of the connecting member 40.

Accordingly, in cross-section laterally of the support surface 44a, the positioning portion 44 has positioning surfaces 44b. The positioning surfaces 44b extend away from the support surface 44a and towards the connecting member 40 in such a way that the surfaces 44a, 44b form a projection with a trapezoidal cross-section in this example, and that the projection tapers in the direction of the mounting plate 10.

The positioning surfaces 14b, 44b thus form entry ramps for the corresponding positioning surfaces 44b, 14b of the respective other part 10, 40. So, upon placing, the connecting member 40, with its positioning surfaces 44b, reaches a supporting contact with the corresponding positioning surfaces 14b of the mounting plate 10, wherein the connecting member 40, on account of the above explained slanted execution illustrated in FIG. 3, is aligned with regard to the mounting plate 10, centred in this case, and thereupon is held in this position.

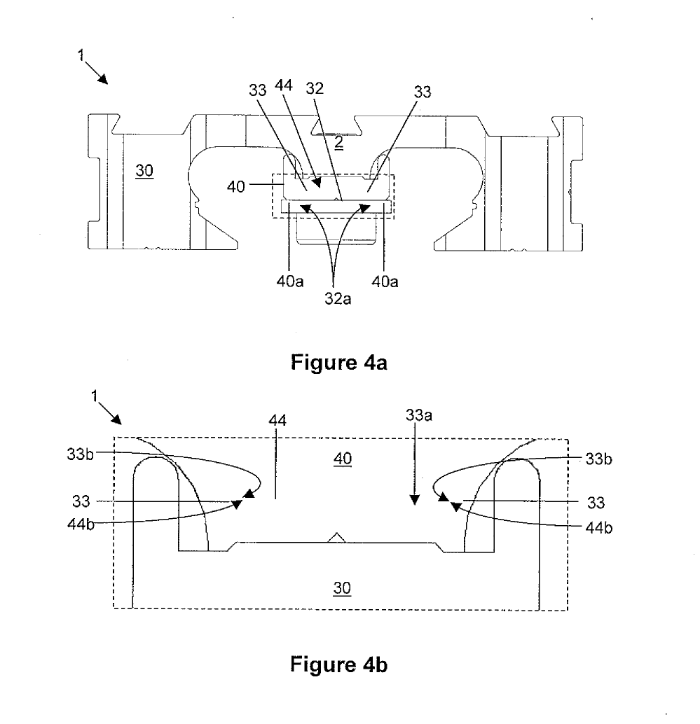

FIG. 4a shows a similar sectional view, however this time according to line B-B in FIG. 1, namely through the mounting plate 30. Advantageously, in cross-section, the mounting plate 30 is configured to be identical to the mounting plate 10 according to FIG. 3. This means it has a fastening portion 32 which laterally has lateral wall sections 32a. The connecting member 40, by being braced between the lateral wall sections 40a of the connecting member 40 and the lateral wall sections 32a of the mounting plate 30, is stationarily fixed to the mounting plate 30 on account of the screwed connection by means of the associated attachment screw 2, a fact which has the same advantages as described with regard to FIG. 3.

As an alternative or in addition, as illustrated in this case, at the sides of the positioning portion 44, the mounting plate 30, in the illustrated mounted condition, has positioning portions 33, which are configured to be similar or identical to the positioning portions 14 of the mounting plate 10 and bears against the positioning portion 44.

The area, which is surrounded by a dashed line in FIG. 4a, is shown enlarged in FIG. 4b. The cooperation between the positioning portions 33, 44 is similar to the above explained cooperation between the positioning portions 14, 44.

Thus positioning surfaces 33b adjoin a support surface 33a laterally in cross-section. The positioning surfaces 33b extend preferably likewise away from the support surface 33a and towards the connecting member 40 such that the surfaces 33a, 33b form a groove with a trapezoidal cross-section and the groove widens in the direction of the connecting member 40.

The positioning surfaces 33b, 44b thus form entry ramps for the corresponding positioning surfaces 44b, 33b of the respective other part 30, 40. Upon placing the connecting member 40 with its positioning surfaces 44b reaches a supporting contact with the corresponding positioning surfaces 33b of the mounting plate 30. The connecting member 40, on account of the above explained slanted execution illustrated in FIG. 3, is aligned with regard to the mounting plate 30, centred in this case, and thereupon is held in this position.

If all the mounting plates 10, 20, 30 of the system 1 are configured to be identical in cross-section, they can be manufactured from one and the same continuous casting profile or extruded profile, whereby production cost is considerably reduced.

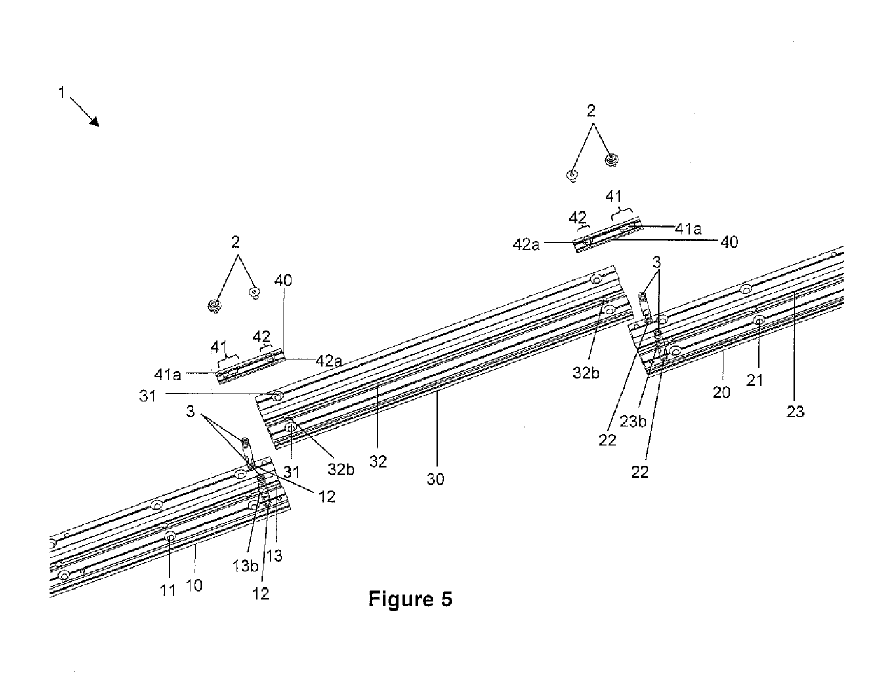

FIG. 5 shows an arrangement of mounting plates 10, 20, 30 of a system 1 for mounting door actuators, according to a second embodiment of the invention. One essential difference is that the mounting plate 30, compared to FIG. 1, is configured longer, namely spans a larger distance between the mounting plates 10, 20 disposed at both ends. Pilot pins 3 are illustrated in this embodiment, which by way of example are inserted into associated reception openings 12, 22 in the mounting plates 10, 20. When placing the respective door actuator onto the respective mounting plate 10, 20, these pins initially fix the door actuator on the associated mounting plate 10, respectively 20. The final screwing of the door actuator to said mounting plate 10, respectively 20 is thereby made easier, because the mechanic no longer has to hold them in place manually. The pilot pins 3 are illustrated to be transparent, in order to make the components of the mounting plate 10, 20 visible, which otherwise would not be visible.

By way of example, the mounting plates 10, 20, 30 are configured in cross-section like the mounting plates 10, 20, 30 according to FIG. 1. This means they have respective fastening openings 11, 21, 31, respectively reception openings 12, 22. As the mounting plate 30 is configured to be relatively long, the connecting member 40 according to FIG. 1 can not be utilized to interconnect all three mounting plates 10, 20, 30. Instead thereof, a respective connecting member 40 is provided for each connection between two mounting plates 10, 30 and 30, 20, disposed directly adjacent to each other. By way of example the connecting members 40 are configured to be identical and, compared to FIG. 1, they have respectively only two fastening portions 41, 42. However, as already described with regard to FIG. 1, they may have three or more fastening portions 41 to 43. The fastening portion 41 has an fastening opening 41a preferably in the shape of an oblong hole. By way of example, the respective other fastening portion 42 comprises a fastening opening 42a configured as circular through-openings. Again respective attachment screws 2 are utilized to affix the connecting member 40 to the respective mounting plates 10, 20, respectively 20, 30. Furthermore, to reliably position the connecting member 40 and the respective mounting plates 10, 20, 30 with respect to each other, preferably by bracing them as mentioned before and to preferably dispose the mounting plates 10, 20, 30 according to the predetermined specifications such that they are flush and in true alignment. In this illustration, the fastening openings 13b, 23 of the fastening portions 13, 23b are visible, into which, in FIG. 5, the left or right attachment screw 2 is screwed while passing through the respective connecting member 40, 40. Analogously thereto, the mounting plate 30 has correspondingly configured fastening openings 32b at its fastening portion 32, in order to be able to attach the connecting members 40 via their fastening openings 42a.

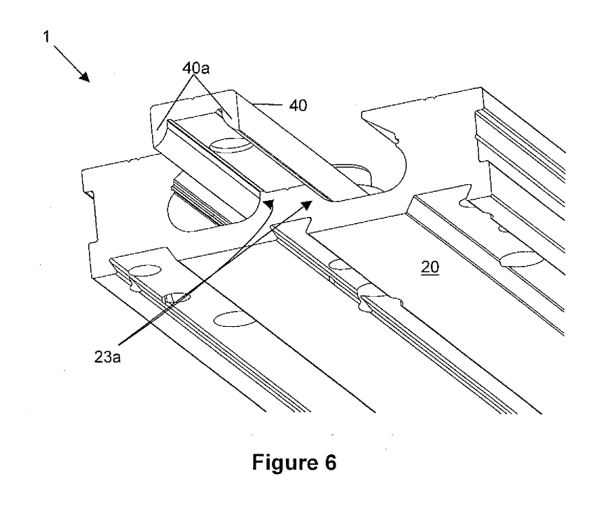

FIG. 6 shows a mounting plate 20 with a connecting member 40 of a system 1 for mounting door actuators, according to a third embodiment of the invention. For illustration purposes, the mounting plate 10 has been omitted, which is connected to the mounting plate 20 by the connecting member 40. At the surfaces facing each other, the lateral wall sections 40a of the connecting member 40 are configured to be complementary to the facing surfaces of the adjoining, opposite lateral wall sections 23a of the mounting plate 20. Therefore, the connecting member 40, with the lateral wall sections 40a, abuts flat against the corresponding lateral wall sections 23a, in this case of the mounting plate 20. A particularly simply and exact positioning of the connecting member 40 on the respective mounting plate 20 is thereby achieved.

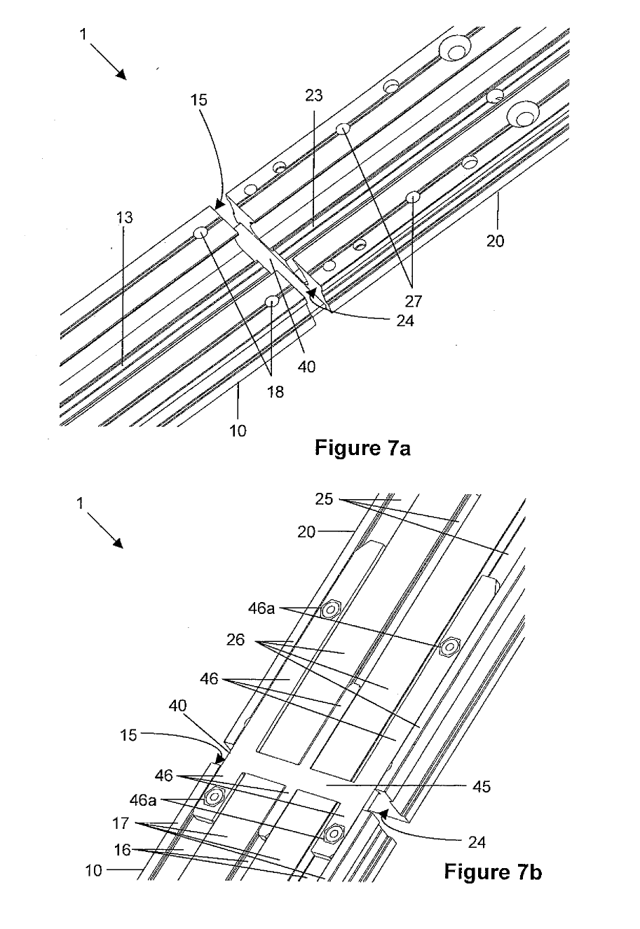

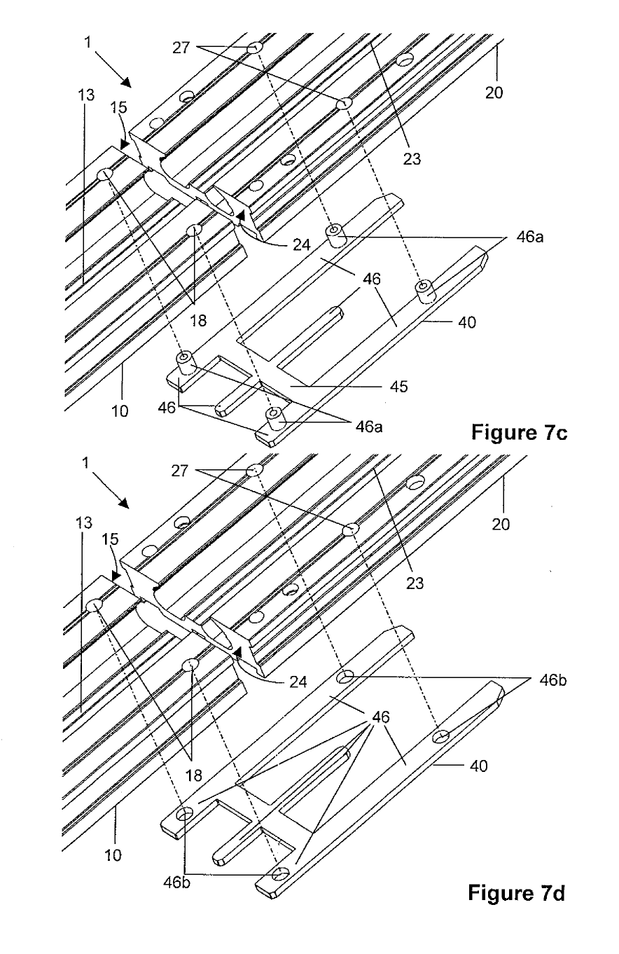

FIGS. 7 and 7b show an arrangement of two mounting plates 10, 20 of a system 1 for mounting door actuators, according to a fourth embodiment of the invention. In contrast to the previous embodiments, the connecting member 40 is disposed at a side of the respective mounting plate 10, 20, which side faces away from the fastening portion 13, 23 and is opposite thereto. This side corresponds to the side of the respective mounting plate 10, 20 facing the aforementioned body. The mounting plates 10, 20, to be interconnected by the connecting member 40, certainly have a distance to each other, but the connecting member 40 does not take up any space above the fastening portion 13, respectively above the hollow space in which it is configured. This means, in this case, the fastening portion 13 can be omitted.

FIG. 7b shows the arrangement of FIG. 7a from the side of the mounting plates 10, 20 facing the body. As can be seen, the connecting member 40 has a central web 45. In the mounted condition, the central web 45 essentially extends vertically with regard to a longitudinal extension of the mounting plates 10, 20 and preferably abuts against respectively facing frontal faces 15, 24 of the mounting plates 10, 20. Only the frontal face 24 of the frontal faces 15, 24 is visible. By way of example respectively three arm portions 46 protrude from the central web 45 in the direction of one of the respective mounting plates 10, 20. The arm portions 46 are preferably dimensioned such that they engage in an accurately fitting manner in an associated reception groove 16, 25 of the respective mounting plates 10, 20. The reception grooves 25 have the same function as the reception grooves 16 and are preferably configured to be identical thereto. In the mounted condition, the connecting member 40 does not protrude with regard to the projections 16, 25. Preferably, the connecting member 40 terminates flush with the projections 17, 26 such that a continuous flat surface is formed. Thus, even with the connecting member 40, the mounting plates 10, 20 can still be installed at the body.

Preferably the number of arm portions 46 corresponds to the number of reception grooves 16, 25 of the respective outermost mounting plates 10, 20 to be interconnected by means of the connecting member 40.

As can be seen in FIG. 7b, the arm portions 46, pointing in the direction of the mounting plate 10, are shorter by way of example than the arm portions 46 pointing in the direction of the mounting plate 20. Longer arm portions 46 allow for inserting a non-illustrated mounting plate, and for additionally disposing it between the mounting plates 10, 20.

Furthermore, as shown in FIG. 7b and FIG. 7c, by way of example, the connecting member 40 preferably has only one respective screw portion 46a at the respective exterior arm portions 46. The screw portions 46a are configured as bushings, which respectively have a female thread. The bushings extend in a same direction perpendicular to a longitudinal extension of the arm portions 46 and perpendicular to a longitudinal extension of the central web 45. In the mounted condition, the bushings point in the direction of the respective mounting plate 10, 20.

At corresponding locations, here at the exterior projections 17, 26, the associated mounting plate 10, 20 has through-openings 18, 27. In the mounted condition, the bushings are received in the corresponding through-openings 15, 26, as indicated by the dash-dotted lines. The mounting plates 10, 20 and the connecting member 40 are thereby initially fixed with regard to each other. Now, even if they are not illustrated, attachment screws are inserted into the through-openings 18, 27 from the side of the mounting plates 10, 20 facing away from the connecting member 40, and screwed to the bushings. The mounting plates 10, 20 and the connecting member 40 are thereby affixed to each other.

The bushings are preferably pressed into or conformed to the connecting member 40, or configured or affixed to the connecting member 40 in any other way.

Instead of bush-type screw portions 46a, a respective through-opening 46b can be configured, such as shown in FIG. 7d. If the respective through-opening 46b has a female thread as well, the connecting member 40 can be screwed to the mounting plates 10, 20 like in the previous embodiment.

As an alternative, the through-openings 18, 27 have a female thread. Now passing through the through-openings 46b, attachment screws can be screwed to the mounting plates 10, 20.

Again as an alternative, the connecting member 40 and the mounting plates 10, 20 are affixed to each other by screw-nut connections.

In addition or as an alternative, in cross-section, the arm portions 46 are configured to be complementary to the corresponding reception grooves 16, 25 of the mounting plates. This means, if the reception grooves 16, 25 are configured dovetail-shaped, trapezoidal or parallelogram-shaped, such as illustrated in cross-section in FIG. 3a, the arm portions 46 are likewise configured dovetail-shaped, trapezoidal or parallelogram-shaped in cross-section. If the wall sections 16a of the reception grooves 16, in this case of the mounting plate 10, extend at an acute angle with regard to the aforementioned support surface 19, the connecting member 40 can be prevented from moving out of the respective mounting plate 10, in the direction away from the support surface 19. The same may apply to the mounting plate 20.

As an alternative or in addition, when mounting, a clamping action is created between the reception grooves 16, 25 and the arm portions 46, which makes mounting easier.

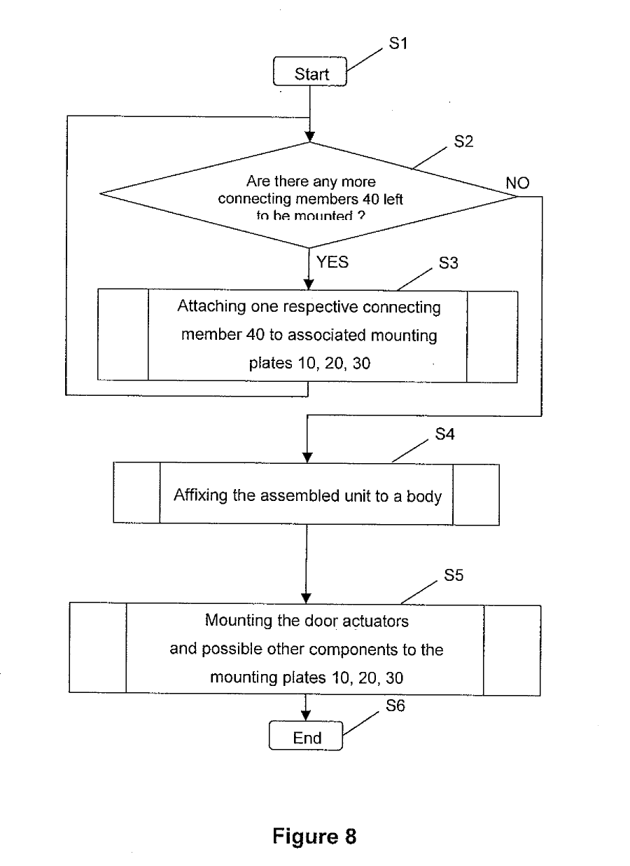

The above described mounting plate systems 1 allow for a mounting method flowchart of FIG. 8. After starting the mounting method in a step S1, it will be initially checked in a following step S2 whether or not more connecting members 40 need to be mounted, namely need to be attached to corresponding mounting plates 10, 20, 30. If this is the case, (YES-branch following step S2), the respective connecting member 40 is attached to associated mounting plates 10, 20, 30 in a step S3, preferably by means of attachment screws 2. Thereafter, the method returns to step S2.

If all the connecting members 40 are mounted (NO-branch following step S2), the unit thus formed by the mounting plates 10, 20, 30 and the connecting member(s) 40 will be attached or affixed to a body, for example a door frame or the like, in a following step S4. As now a complete mounting plate is created in the shape of this unit, it can be mounted in a traditional way, as if a single mounting plate only were to be mounted.

Thereby the basis is provided to affix all components, such as door actuators and all additional components, such as smoke detectors or the like, communicating therewith, to the mounting plate(s) 10, 20, 30 in a following step S5. If the above described mounting plate 30 is configured to be similar to the mounting plate 10, 20, the additional components are advantageously affixed to this intermediate mounting plate 30. It is possibly necessary to run appropriate cables. Mounting the door actuator arrangement is thereafter completed and just needs to be provided with a possible covering, for example in the shape of a cover shield.

The above described mounting method ends in a step S6.

As a result, the method presents very few mounting steps which are very simple to carry out, which, on the one hand makes mounting easier, and on the other hand, reduces possible mounting errors or even helps avoiding them.

In the event, that there is only one connecting member 40, the step S2 can be omitted. Starting with step S1, the method continues directly with step S3 and thereafter jumps directly to step S4.

The invention is not limited to the above embodiments. For example the fastenings portions 13, 23, 32 of the mounting plates 10, 20, 30 can be configured to be provided only in the areas, where a respective associated connecting member 40 will be placed. This means, at their respective ends, the mounting plates 10, 20, 30 have respectively one of two fastening portions 13, 23, 32. This means the mounting plates 10, 20 just need to present one fastening portion 13, 23 at the end facing the mounting plate 30. This results in the advantage that the respective mounting plate 10, 20 is mounted in a correctly oriented manner.

In addition, instead of one, the fastening portions 13, 23, 32 of the respective mounting plate 10, 20, 30 may have several fastening openings 13b, 23b, 32b.

As an alternative or in addition, the lateral wall sections 40a, 40a may be configured such that their distance with regard to each other increases in the direction of the respective mounting plate 10, 20, 30 or even is configured to be complementary to the lateral wall sections 13a, 23a, 32a. In this case, the lateral wall sections 13a, 23a, 32a can be configured like the lateral wall sections 40a according to FIG. 3.

The fastening portions 41 to 43; 13, 23, 32 of the connecting member 40 and of the mounting plate 10, 20, 30 can have a reversed configuration, such that the connecting member 40 has a projection configured at the side facing the mounting plates 10, 20, 30 and the fastening portions 13, 23, 32 of the mounting plates 10, 20, 30 have a U-shaped reception space in cross-section, for the projection of the connecting member 40.

In addition or as an alternative, the fastening portions 41 to 43; 13, 23, 32 of the connecting member 40 and of the mounting plate 10, 20, 30 may have a reversed configuration such that the connecting member 40 has a projection configured at the side facing the mounting plates 10, 20, 30 and the fastening portions 13, 23, 32 of the mounting plates 10, 20, 30 have a U-shaped reception space in cross-section for the projection of the connecting member 40.

As a result, the invention provides a mounting plate 10, 20, which, in addition to its proper function of affixing a door actuator to a body, furthermore, based on its design, can be disposed and fixed with regard to other mounting plates 20, 30 in a simple manner by means of a connecting member 40. A very flexible system 1 is thus created in conjunction with the connecting member(s) 40, in order to form one united mounting plate from several mounting plates 10, 20, 30, onto which a continuous cover shield can be placed for example. Moreover, the shorter mounting plates 10, 20, 30 resulting therefrom are easier to transport and to package than a single long mounting plate, and they require less space.

The above described connecting members may have additional fastening devices such as screw holes for affixing for example electrical components, like sensors or the like.

In addition, the mounting system 1 offers the above described very simple mounting method.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A mounting plate for a door actuator, configured to be attached to a body carrying the mounting plate and to move a connected door leaf in at least one direction, the mounting plate comprising:
a plurality of fastening devices for affixing the door actuator to the mounting plate; and
at least one fastening portion in longitudinal extension of the mounting plate arranged at least at one end of the mounting plate configured to stationarily receive a connecting member.

2. A mounting plate according to claim 1, wherein the at least one fastening portion extends over an entire length of the mounting plate.

3. A mounting plate according to claim 1, wherein the at least one fastening portion has at least one through-opening comprising at least one of a female thread and an oblong hole.

4. A system for mounting at least one door actuator, comprising:
a mounting plate for the at least one door actuator, configured to be attached to a body carrying the mounting plate and to move a connected door leaf in at least one direction, the mounting plate comprising:
a plurality of fastening devices for affixing the door actuator to the mounting plate; and
at least one fastening portion in longitudinal extension of the mounting plate arranged at least at one end of the mounting plate configured to stationarily receive a connecting member;
an additional mounting plate, having at least one second fastening portion for attaching a second section of a connecting member, said section facing the additional mounting plate; and
at least one connecting member seen in the longitudinal extension having respective sections at its ends, which respectively are:
configured as a fastening portion, and
adapted to be attached to a respective facing fastening portion of a respective one of the mounting plates such that the mounting plates, attached to the connecting member are aligned with regard each other according to predetermined specifications.

5. The system according to claim 4, wherein the additional mounting plate is configured to be attached to the body.

6. The system according to claim 4, wherein at least one fastening portions of the mounting plates extends over an entire length of at least one of the mounting plates.

7. The system according to claim 6, wherein the respective fastening portions of the respective connecting member present comprise at least one corresponding through-opening, which is respectively configured with one of a female thread and an oblong hole for each through-opening of the respective mounting plate to be affixed.

8. The system according to claim 4, further comprising:
a second door actuator; and
a second mounting plate configured according to the first mounting plate.

9. The system according to claim 8, wherein at least one of the at least one connecting member, seen in longitudinal extension, has a central portion between the two sections, the connecting member:
configured as a fastening portion; and
adapted to be attached to the additional mounting plate by a central portion such that the first mounting plate, the second mounting plate and the additional mounting plate, affixed to the connecting member, aligned with regard to each other according to predetermined specifications.

10. The system according to claim 9, wherein the alignment includes a true alignment of the mounting plates affixed to the connecting member.

11. A method for affixing at least two mounting plates of a system comprising:
attaching, by respective attachment elements, each connecting member to the mounting plates, which are aligned with regard to each other by a respective connecting member via respective fastening portions corresponding to each other; and
placing and attaching the unit thus formed from the connecting member, respectively the connecting members and the mounting plates on, respectively to the body.

12. The method according to claim 11, wherein the attachment elements comprise screws, and the step of attaching is accomplished by screwing together the connecting member and the respective mounting plate.
